(19) United States
(12) Patent Application Publication
(10) Pub. No.: US 2008/0035236 A1
(43) Pub. Date: Feb. 14, 2008

(54) Fuel filler port closing apparatus

(75) Inventor: Hiromitsu Yoshida, Soja-shi (JP)

Correspondence Address: QUINN EMANUEL;KODA & ANDROLIA, 865 S. FIGUEROA STREET, 10TH FLOOR, LOS ANGELES, CA, 90017, US

(73) Assignee: Asteer Co., Ltd.

(21) Appl. No.: 11/881,290

(22) Filed: Jul. 26, 2007

(30) Foreign Application Priority Data
Aug. 11, 2006 (JP) 2006-220071

(51) Int. Cl. B65B 1/04; B60K 15/05

(52) U.S. Cl. 141/98; 220/304

(57) ABSTRACT

The invention provides a shutter-operated fuel filler port closing apparatus in which a countermeasure for static electricity is applied. The shutter-operated fuel filler port closing apparatus includes a dust cover which is capable of tilting for closing up a fuel filler port and a hinged haft for the dust cover which have electrical conductivity, and the hinged shaft and a filler neck are electrically connected by an electrically conductive leaf spring, so that static electricity is discharged from the dust cover to the filler neck through the hinged shaft and the electrically conductive leaf spring. Since the dust cover is opened always with a hand or hands for fueling, the static electricity can be discharged inevitably to the filler neck through actions to open the dust cover, so that spark discharge can be prevented.

### BACKGROUND OF THE INVENTION

1. Field of the Invention

The present invention relates to a fuel filler port closing apparatus in which a shutter pressed against the inside of a fuel filler port opens the fuel filler port by being pressed by a fuel filler nozzle inserted therein, and closes the fuel filler port by being restored when the fuel filler nozzle is pulled out.

2. Description of the Related Art

An ordinary fuel filler port closing apparatus in which a fuel filler port is opened by removing a fuel filler cap and is closed by mounting the fuel filler cap has an advantage in that the fuel filler cap is tightened to the fuel filler port via, for example, a seal ring, so that air-tightness and liquid-tightness of the fuel filler port are easily obtained. However, it is troublesome to attach and detach the fuel cap to be tightened to the fuel filler port, and in case the fuel cap is tightened inappropriately, the seal ring can be deformed, so that the air-tightness and the liquid-tightness can be impaired. In addition, the fuel filler cap detached from the fuel filler port may have a misfortune to be lost.

Therefore, as disclosed in U.S. Pat. No. 6,092,685 A, DE 69802405 T2, U.S. Pat. No. 6,009,920 A, WO 98/45183 A1, U.S. Pat. No. 6,942,117 B2, DE 102005042529 A1 and US 2006/0048823 A1, a fuel filler port closing apparatus in which a shutter pressed against the inside of a fuel filler port opens the fuel filler port by being pressed by a fuel filler nozzle inserted therein, and closes the fuel filler port by being restored when the fuel filler nozzle is pulled out is proposed. The shutter-operated fuel filler port closing apparatus is advantageous in that an event that a user forgets to put the fuel filler cap back to the fuel filler port cannot be happened as a matter of course, and in that a fuel filler pipe continuing from the fuel filler port can be blocked out from the outside until the fuel filler nozzle is actually inserted, and presses and opens the shutter, so that discharge of fuel vapor is restrained.

The respective shutter-operated fuel filler port closing apparatuses disclosed in U.S. Pat. No. 6,092,685 A, DE 69802405 T2, U.S. Pat. No. 6,009,920 A, WO 98/45183 A1, U.S. Pat. No. 6,942,117 B2, DE 102005042529 A1 and US 2006/0048823 A1 are each provided with a dust cover for opening and closing a fuel filler port. The dust covers disclosed in DE 69802405 T2, U.S. Pat. No. 6,009,920 A, U.S. Pat. No. 6,092,685 A, WO 98/45183 A1 and U.S. Pat. No. 6,942,117 B2 are each urged by a turnover spring or the like and are forcedly closed. The dust covers disclosed in DE 102005042529 A1 and US 2006/0048823 A1 are each prevented from opening unintentionally by engaging a clamp with a fuel filler port.

High air-tightness and liquid-tightness are required for the fuel filler port in order to restrain or prevent an emission of the fuel vapor. However, the possibility of leak of the fuel vapor, for example, due to damage of the shutter cannot be denied. When a breather pipe is opened at the fuel filler port or in the vicinity thereof in order to release the pressure increased by the fuel vapor staying in a fuel tank, there can be a case in which the fuel vapor is emitted at the fuel filler port or in the vicinity thereof. In recent years, a possible danger of ignition of the fuel vapor emitted at the fuel filler port or in the vicinity thereof by a spark which is generated by static electricity discharged from a human body to a car body when fueling has been pointed out. Therefore, it is required to provide the fuel filler port with a countermeasure for the static electricity. However, in U.S. Pat. No. 6,092,685 A, DE 69802405 T2, U.S. Pat. No. 6,009,920 A, WO 98/45183 A1, U.S. Pat. No. 6,942,117 B2, DE 102005042529 A1 and US 2006/0048823 A1, there is no clear description or suggestion of the countermeasure for the static electricity. Therefore, the countermeasure for the static electricity for the shutter-operated fuel filler port closing apparatus has been studied.

### SUMMARY OF THE INVENTION

As a result of study, a following shutter-operated fuel filler port closing apparatus is developed. That is the shutter-operated fuel filler port closing apparatus including a body member having a fuel filler port formed therethrough and a shutter rotatably attached thereto by means of a pivot shaft and pressed against the fuel filler port from the inside thereof; a cover mounting base fitted around a filler neck in which the body member is fitted; and a dust cover rotatably attached to the cover mounting base by means of a hinged shaft, wherein the dust cover is formed of an electrically conductive resin material and is electrically connected to the filler neck through an electrically conductive member, and wherein static electricity charged in a hand or hands which touch the dust cover is discharged from the dust cover to the filler neck through the electrically conductive member.

The shutter in the shutter-operated fuel filler port closing apparatus closes up the fuel filler port provided on a member attached to an end of a fuel filler pipe by being pressed against from the inside thereof. When a guide member having an opening which communicates with the fuel filler port is provided, the shutter is pressed from the inside of the opening provided on the guide member to close up the opening. In other words, when the guide member provided with the opening which communicates with the fuel filler port is disposed, the invention can be applied by regarding the opening of the guide member as the fuel filler port.

The shutter-operated fuel filler port closing apparatus is provided with the dust cover for closing up the fuel filler port so that dust or rain water can not accumulate outside the shutter. Normally, the fuel filler port provided with the shutter-operated fuel filler port closing apparatus is disposed within a housing hidden by a vehicle body lid. In this case, the vehicle body lid is opened by operating in a cabin, there is no chance to touch the dust cover with a hand or hands so that it cannot be expected to discharge static electricity in a human body through the vehicle body lid. Therefore, this invention provides the dust cover formed of an electrically conductive resin material to provide electrical conductivity so that the static electricity can be discharged from a hand or hands which touch the dust cover to the filler neck which has the same electric potential as the vehicle body.

The degree of the electrical conductivity required for the dust cover is the extent that the dust cover has an adequate electric resistance causing no spark discharge until it is touched by a hand or hands but allowing an electric current to flow between the hand or hands, which have high potential due to static electricity, and the filler neck, which has ground potential, when the hand or hands touch the filler neck. From this reason, the dust cover is preferably formed of an electrically conductive resin material whose volume resistivity is in a range between 10⁴ Ωcm to 10⁷ Ωcm. More specifically, the dust cover is formed of an electrically conductive resin material obtained by mixing powder of an electrically conductive material (such as carbon black) or short-fiber (such as carbon whisker) with a resin material such as nylon or polyethylene normally used for vehicle members.

As a specific example of the shutter-operated fuel filler port closing apparatus, preferably, the hinged shaft is formed of a metallic material, is electrically connected to the dust cover by direct contact and is electrically connected to the filler neck through the electrically conductive member, and the static electricity in a hand or hands which touch the dust cover is discharged from the dust cover to the filler neck through the hinged shaft and the electrically conductive member. Since the hinged shaft is electrically connected to the dust cover constantly irrespective of an opening-and-closing state of the dust cover, the static electricity can be discharged from the dust cover to the filler neck through the hinged shaft and the electrically conductive member not only when the dust cover is opened, but also when a hand or hands are released from the dust cover once for fueling and then the hand or hands touch the dust cover again in order to close it after fueling.

The electrically conductive member to electrically connect the hinged shaft and the filler neck can be of any member as long as it has an electrical conductivity higher than the dust cover, and is substantially regarded as an extension of the filler neck. The electrically conductive member used in the shutter-operated fuel filler port closing apparatus of the above configuration is preferably an electrically conductive leaf spring pressed against the hinged shaft and secured to the filler neck. Since the electrically conductive leaf spring is simply pressed against the hinged shaft, it has an advantage in that it does not impair the rotation of the hinged shaft even when the hinged shaft rotates in association with the opening-and-closing motion of the dust cover.

Alternatively, the shutter-operated fuel filler port closing apparatus may have a following configuration. That is, the hinged shaft is formed of a metallic material and is electrically connected to the dust cover by direct contact, and the cover mounting base is formed of an electrically conductive resin material so as to serve as an electrically conductive member, is electrically connected to the hinged shaft via a bearing stand and is electrically connected to the filler neck by direct contact. Accordingly, the static electricity in a hand or hands which touch the dust cover is discharged from the dust cover to the filler neck through the hinged shaft, the bearing stand and the cover mounting base. In this configuration, the cover mounting base serves as the electrically conductive member. The cover mounting base formed of the electrically conductive resin material preferably has an electrical conductivity higher than the dust cover.

The invention provides a countermeasure for static electricity for the shutter-operated fuel filler port closing apparatus at the fuel filler port. Since the dust cover is always opened with a hand or hands for fueling, the static electricity is inevitably discharged to the filler neck through the action to open the dust cover, so that spark discharge is prevented. When the dust cover is designed to interfere with the vehicle body lid when it is opened, the dust cover must be closed in order to close the vehicle body lid after fueling, so that the dust cover must be opened again in the next fueling occasion. Accordingly, the occasion to touch the dust cover with a hand or hands is secured. In this manner, this invention make it possible that the static electricity charged in a human body can be inevitably discharged to the filler neck through the dust cover by means of providing the dust cover, which must be operated always with a hand or hands for fueling, with electrical conductivity so that the dust cover and the filler neck can be electrically connected.

### BRIEF DESCRIPTION OF THE DRAWINGS

FIG. 1 is a cross-sectional view of a shutter-operated fuel filler port closing apparatus in which a dust cover is electrically connected to a filler neck through a hinged shaft of a dust cover; and

FIG. 2 is a plain view of the shutter-operated fuel filler port closing apparatus corresponding to FIG. 1; and

FIG. 3 is a cross-sectional view of an open-stated shutter-operated fuel filler port closing apparatus corresponding to FIG. 1

### DESCRIPTION OF THE PREFERRED EMBODIMENTS

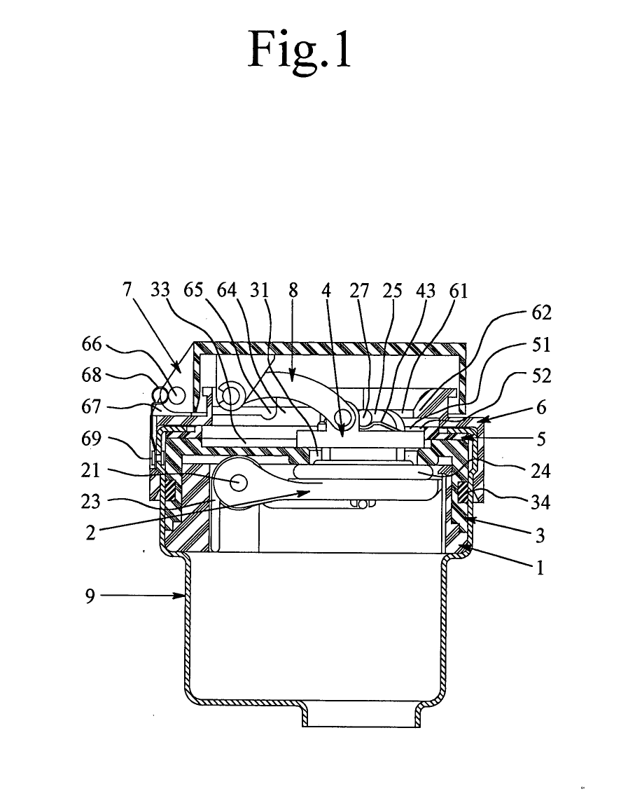

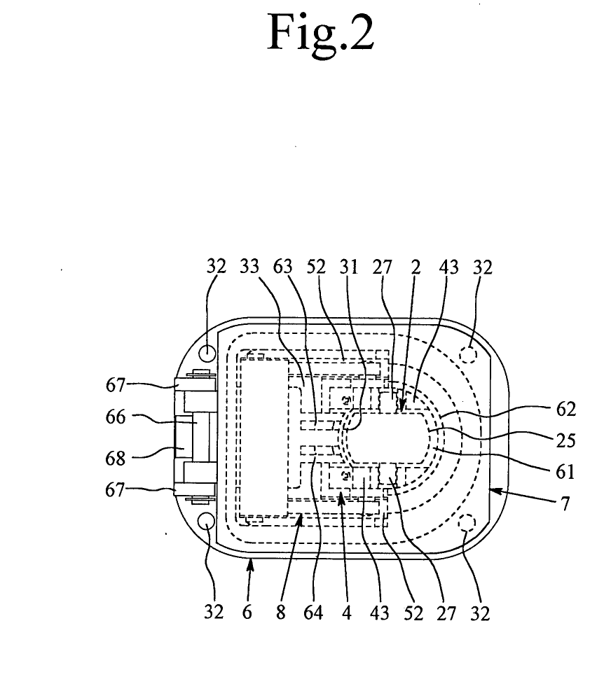

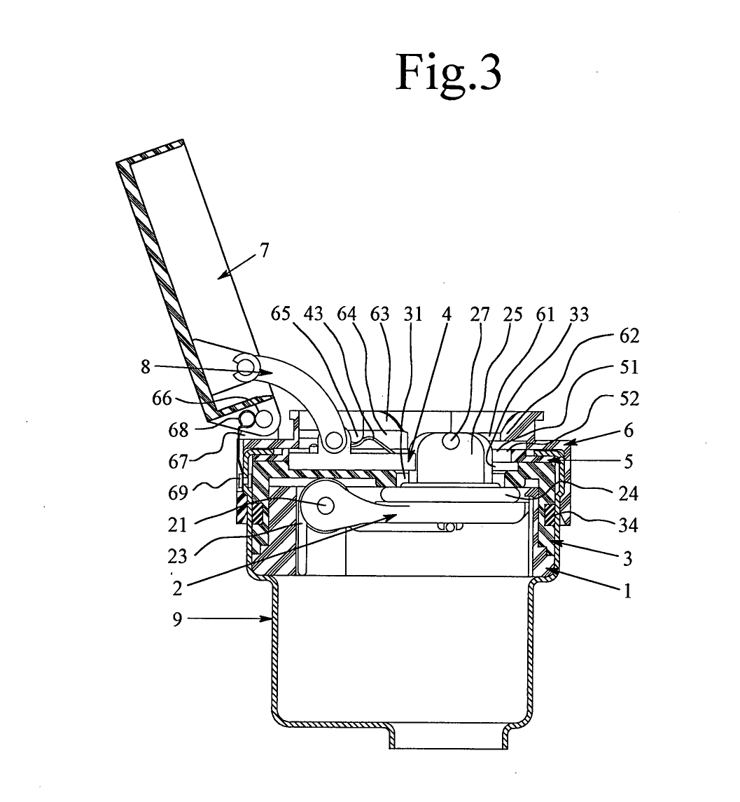

Referring to the drawings, an embodiment of the invention will be described. FIG. 1 is a cross-sectional view of a shutter-operated fuel filler port closing apparatus in which a dust cover 7 is electrically connected to a filler neck 9 through a hinged shaft 66 of the dust cover 7, FIG. 2 is a plain view showing the shutter-operated fuel filler port closing apparatus in which the dust cover 7 is electrically connected to the filler neck 9 through the hinged shaft 66 of the dust cover 7, and FIG. 3 is a cross-sectional view, which corresponds to FIG. 1, showing a state in which the dust cover 7 is opened.

As shown in FIG. 1 and FIG. 2, the shutter-operated fuel filler port closing apparatus in this embodiment includes a body member which consist of a lower body member 1 and an upper body member 3, a guide plate 5 and a cover mounting base 6. The lower body member 1, the upper body member 3, the guide plate 5 and the cover mounting base 6 are assembled into the filler neck 9 in this sequence from the bottom to upward. The positional relationship between the lower body member 1 and the upper body member 3 is defined by mutual fitting, and the positional relationship among the upper body member 3, the guide plate 5 and the cover mounting base 6 is defined by inserting four positioning projections 32 formed on the upper surface of the upper body member 3 so as to project therefrom through the guide plate 5 and the cover mounting base 6 (see FIG. 2).

The lower body member 1 is formed of a resin cylindrical block to be fitted to the filler neck 9 from above. A shutter 2 is rotatably attached to a pivot shaft 21 supported by the inner surface of the lower body member 1, and is urged in a direction to close a fuel filler port 31 (counterclockwise direction in FIG. 1), which is opened through the upper body member 3, by a restoring force of a torsion coil spring 23 fitted around the pivot shaft 21. The shutter 2 in this embodiment includes a seal ring 24 having a size which can circumscribe the fuel filler port 31 and fitted on the upper surface of the shutter 2, and a fitting projection 25 formed integrally with the shutter 2 and projecting therefrom. The fitting projection 25 has a pair of rod-shaped engaging portions 27 protruding in the direction orthogonal to the tilting direction of the dust cover 7. The engaging portions 27 are protruded within a range which can be accommodated within the fuel filler port 31 (see FIG. 2).

The upper body member 3 is a resin cylindrical block to be fitted on the lower body member 1 from above and has the fuel filler port 31 within a track frame portion 33 to which a slide member 4 is to be fitted. Both side edges of the slide member 4 are pressed downward by guide rails 52 of the guide plate 5 described later. The upper body member 3 in this embodiment presses a seal packing 34 fitted on the outer surface thereof against the inner surface of an upper large-diameter portion of the filler neck 9. Furthermore, the upper body member 3 in this embodiment presses ends of the pivot shaft 21 supported by the inner surface of the lower body member 1 downward by holding member (not shown) for retaining the pivot shaft 21.

The guide plate 5 is a resin plate-shaped member to be assembled to the upper body member 3. The guide plate 5 is provided with a plate opening 51 which corresponds to the track frame portion 33 provided on the upper body member 3, and the guide rails 52 along edges of the plate opening 51. The guide plate 5 is provided with four positioning holes and, as described before, is positioned with respect to the upper body member 3 by having the four positioning projections 32 (see FIG. 2), provided on the upper surface of the upper body member 3, inserted through the four positioning holes.

The slide member 4 slides in the fore-and-aft direction with respect to the fuel filler port 31 in conjunction with the opening and closing motion of the dust cover 7 through the connection via a link arm 8. The slide member 4 moved forward in conjunction with the dust cover 7 tilted downward engages recesses of leaf springs 43 attached to the upper surface thereof with the engaging portions 27 protruded from the fitting projection 25 projected upwardly out of the fuel filler port 31 from below to constrain the shutter 2 from opening (see FIG. 1 and FIG. 2). When the dust cover 7 is tilted upward, the slide member 4 slides backward and releases the leaf springs 43 from the engaging portions 27, and engages the recesses of the leaf springs 43 in turn with detent projections 65 formed on the left and right sides of a guide block 64 from below. The shutter 2 in which the engagement between the engaging portions 27 and the leaf springs 43 is released (shown in FIG. 3) can be opened by being pressed and rotated downward, for example, with a fuel filler nozzle (not shown). The cover mounting base 6 is a resin box-shaped member to be fitted around the filler neck 9 from above after having the lower body member 1, the upper body member 3 and the guide plate 5 fitted integrally into the filler neck 9 as described before. The cover mounting base 6 has a cover opening 61, which corresponds to the track frame portion 33 provided on the upper body member 3, on the upper surface thereof. As described later, by forming the cover mounting base 6 of an electrically conductive resin material, it serves as an electrically conductive member like an electrically conductive leaf spring 68. The dust cover 7 is a box-shaped member formed of an electrically conductive resin material to be attached to the hinged shaft 66 held by bearing stand 67 and provided outside the cover opening 61, and includes the link arms 8 attached to a shaft in the inside thereof. In addition, as described before, the cover mounting base 6 is positioned with respect to the upper body member 3 and the guide plate 5 by inserting the four positioning projections 32 (see FIG. 2) formed on the upper surface of the upper body member 3.

The cover opening 61 in this embodiment is provided with a guide flange 62 and a guide rib 63 so as to surround the fuel filler port 31 for guiding the fuel filler nozzle toward the fuel filler port 31. The guide flange 62 is a fan-shaped flange extending over a range corresponding to half around the fuel filler port 31. The guide rib 63 is provided on the upper surface of the guide block 64 which is arranged at a position opposite to the guide flange 62. The guide rib 63 has a wall surface which is arranged in the direction of the radius of the fuel filler port 31. These members guide the fuel filler nozzle to the fuel filler port 31.

The shutter-operated fuel filler port closing apparatus in this embodiment employs the electrically conductive leaf spring 68 as the electrically conductive member. The electrically conductive leaf spring 68 is fixed at the lower end thereof to the filler neck 9 by opening a part of a side surface of the cover mounting base 6 and fitting an electrically conductive pin 69 over the lower end of the electrically conductive leaf spring 68 in the provided opening, and is brought into press contact with the hinged shaft 66 at the upper end thereof. Since the electrically conductive dust cover 7 is electrically connected to the metallic hinged shaft 66, static electricity charged in a hand or hands which touch the dust cover 7 can be discharged from the dust cover 7 to the filler neck 9 through the hinged shaft 66, the electrically conductive leaf spring 68 and the electrically conductive pin 69. Since the dust cover 7 must be opened with a hand or hands when it is opened for fueling, according to the shutter-operated fuel filler port closing apparatus in this embodiment, static electricity is discharged through the action to open the dust cover 7, so that the danger of spark discharge can be avoided.

Since the electrically conductive leaf spring 68 is pressed against the hinged shaft 66, the electrically conducted state is maintained even when the hinged shaft 66 is rotated in association with the opening and closing operation of the dust cover 7. Therefore, even in a state in which the dust cover 7 is opened for fueling as shown in FIG. 3, by touching the dust cover 7 with a hand or hands again static electricity can be discharged from the dust cover 7 to the filler neck 9 through the hinged shaft 66, the electrically conductive leaf spring 68 and the electrically conductive pin 69. As described before, when the cover mounting base 6 is made of the electrically conductive resin material, static electricity can be discharged from the dust cover 7 to the filler neck 9 through the hinged shaft 66, the bearing stand 67 and the cover mounting base 6 even when, for example, the hand or hands do not touch the dust cover 7 and touch only the cover mounting base 6. In this manner, by providing electrical conductivity with the dust cover 7 and the cover mounting base 6, static electricity can be discharged also when closing the dust cover 7 after fueling, so that the danger of spark discharge can be avoided.

What is claimed is:

1. A fuel filler port closing apparatus comprising:
a body member having a fuel filler port formed therethrough and a shutter rotatably attached thereto by means of a pivot shaft and pressed against the fuel filler port from the inside thereof;
a cover mounting base fitted around a filler neck in which the body member is fitted; and
a dust cover rotatably attached to the cover mounting base by means of a hinged shaft,
wherein the dust cover is formed of an electrically conductive resin material and is electrically connected to the filler neck through an electrically conductive member and
wherein static electricity charged in a hand or hands which touch the dust cover is discharged from the dust cover to the filler neck through the electrically conductive member.

2. The fuel filler port closing apparatus according to claim 1, wherein the hinged shaft is formed of a metallic material, is electrically connected to the dust cover by direct contact, and is electrically connected to the filler neck through the electrically conductive member, and
wherein the static electricity in a hand or hands which touch the dust cover is discharged from the dust cover to the filler neck through the hinged shaft and the electrically conductive member.

3. The fuel filler port closing apparatus according to claim 2, wherein the electrically conductive member is an electrically conductive leaf spring secured to the filler neck and is pressed against the hinged shaft.

4. The fuel filler port closing apparatus according to claim 1, wherein the hinged shaft is formed of a metallic material and is electrically connected to the dust cover by direct contact,
wherein the cover mounting base is formed of an electrically conductive resin material so as to serve as the electrically conductive member, is electrically connected to the hinged shaft via a bearing stand, and is electrically connected to the filler neck by direct contact, and
wherein the static electricity in a hand or hands which touch the dust cover is discharged from the dust cover to the filler neck through the hinged shaft, the bearing stand and the cover mounting base.
